(19) United States
(12) Patent Application Publication
(10) Pub. No.: US 2022/0036279 A1
(43) Pub. Date: Feb. 3, 2022

(54) Git Version Control Analytics

(71) Applicants: Alexandru Laurentiu Circei, Bucharest (RO); Constantin Valentin Buzea, Braila (RO)

(72) Inventors: Alexandru Laurentiu Circei, Bucharest (RO); Constantin Valentin Buzea, Braila (RO)

(21) Appl. No.: 16/945,811

(22) Filed: Aug. 1, 2020

(51) Int. Cl. G06Q 10/06; G06Q 10/10; G06Q 40/00

(52) U.S. Cl. CPC G06Q 10/06398; G06Q 10/1091; G06Q 40/125; G06Q 10/1095; G06Q 10/103; G06Q 10/105; G06Q 10/06393

(57) ABSTRACT

Systems and methods are disclosed herein for a Git Version Control Analytics based on assisting engineering managers gain better visibility into their development team. This tool focuses on increasing team productivity and helps managers be data-driven and provide multiple features including but not limited to an interactive dashboard, statistical arrangements for employee evaluation, metrics for daily stand-ups, 1-to-1 meetings, benchmarking stats with the industry, creation of work log, daily update, time card and project timelines.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserved all copyright rights whatsoever

### BACKGROUND

### Field of the Invention

The present invention relates to a computer application technology, in particular to the field of evaluation of an individual or team participating in engineering team.

### Description of the Related Art

Personnel evaluations have become an integral part of the efforts of companies or entities trying to manage their human resources and measure the contributions of their personnel for efficiency, compensation, and promotion purposes. Too often, however, such personnel evaluations focus on pure performance numbers with respect to performance-driven criteria for its personnel, without considering the contributions or effects of its personnel with respect to desired business culture criteria or goals.

There are multiple patents that have been focused on providing methods and systems of evaluations of personnel. For instance, bearing Korean patent 2,009,001,0957A discloses a system for and method for psychological assessment is issued to Korean inventor. The patent is on systems, methods and program products relating to the assessment of individuals, a subject can be provided with an assessment through software and a computer for improved functionality. The software may be directly installed on the subject's computer or may be on a remote server accessible through a communication network, such as a local network or the Internet. Stimuli to be presented to subject are selected in real time and may be selected randomly from a database of stimuli. Further, in the event of borderline cases, a refinement process may be used to provide an accurate assessment of the subject. Methods for the assessment of teams, comprising subject individuals, for the construction of ideal process profiles, and for coaching individuals are provided.

Another patent on Personnel management systems and related methods bearing US patent 2,013,0238403A1 is issued to EVALUATE TO WIN LLC. The patent discloses embodiments of personnel management systems are presented herein. Other examples, and related methods, are also disclosed herein.

A System inspection, evaluation and team management bearing Spanish patent 2,271,184T3 is issued to Tlv Co Ltd. The patent is on a system (1) inspection and evaluation equipment including a section inspection and evaluation of devices for inspecting and evaluating a plurality of devices forming equipment in accordance with a predetermined inspection and evaluation sequence, characterized in that the system comprising: a section (16) of index memory having stored therein indexes for the respective devices, the indexes being arranged in a predetermined order; a section indices call first calls the previous index and then calls successive indexes one by one in the predetermined every time it is applied by an external index output command; and an output section that extracts index indexes called by the index calling section.

Another System and method for generating an evaluation in a performance evaluation system bearing U.S. Pat. No. 6,604,084B1 is issued to E-TALK Corp Hewlett Packard Development Co LP e talk Corp. The patent discusses an evaluation is generated in a performance evaluation system by defining a plurality of questions. A plurality of performance areas are defined and each associated with at least one of the questions. In response to a request for an evaluation including a performance area, questions associated with the performance area are included in the evaluation.

Another Evaluation system and method bearing Japanese patent 2,017,514241A is issued to Japanese inventor. The present disclosure relates to systems and methods for identifying faults in products or services. The processor receives a request that includes characterization data that identifies the fault. The processor then selects the plurality of tester identifiers based on the capability data associated with each of the plurality of tester identifiers and based on the characterization data to generate a team record. The processor then generates a user interface associated with each of the plurality of tester identifiers in the team record. The user interface includes user control elements that allow the tester to provide a fault description. Through this user interface, the processor receives a plurality of fault records each including a fault description and associated with one of the plurality of tester identifiers of the team record. Finally, the processor stores each of a plurality of fault records associated with a product or service and an associated tester identifier in a data store.

A System and Method of Team Performance Management Software bearing US patent 2,009,0043621A1 is issued to Altova GmbH. The patent is on an application for teams of information workers, their managers, and human resources professionals to evaluate and raise performance based on communication metrics and norms of behavior within a team. A model and management Web pages enable users to collectively set norms of behavior, communicate, make decisions, set roles and goals, receive evaluations according to their norms, and in other ways conduct interpersonal relations in a business context. Modules acquiring data from email and document management systems, groupware, directories, and other information sources are included. Said information is joined with the invention's internally generated data. An expert system generates observations and advice permitting the team to more appropriately deploy information, adhere more closely to its norms, and lessen stress caused by interpersonal friction. Management is provided a means of assessing teams, setting policies, and defining parametric ranges for norms.

Another Performance evaluation systems and methods bearing US patent 2,008,0228549A1 is issued to PEOPLENETZ LLC. The patent is on a performance evaluation system. The system includes a performance evaluation module configured to enable employee performance reviews based on completion of a plurality of tasks and a plurality of skills required to complete the tasks for each of a plurality of projects on which an employee is staffed, wherein the performance evaluation module returns an employee performance score for the employee in relation to other employees at comparable job levels as the employee. The system also includes a project staffing module configured to enable a user to staff a project by selecting at least one candidate employee based on a skill level proficiency rating in a desired skill and a length of time for which the candidate employee has utilized the desired skill. The system further includes a skills management module configured to enable a user to search a database for persons who have a specified skill and an external contacts module configured to enable a user to search for contact information in the database.

Looking at the prior art in a similar field, the improvement in effective utilization of technology and expansion in their utility for every type of field is greatly challenged. The current personnel evaluation tools fail to consider the interaction between such performance criteria and business culture criteria for the personnel being evaluated and fail to provide a metric and/or a graphical representation of such interaction. Furthermore, the personnel evaluation for engineering teams is also not fairly practiced. Moreover traditionally, engineering has relied on narrative, and subjective metrics like story points and tickets cleared to demonstrate business value.

Considering the above, further developments can be made to positively impact personnel management systems and related methods for engineering teams, focusing on increased visibility about team contributions, see where the most significant impact is being made, identify areas to give concrete feedback, and help teams understand how process changes impact the team's effectiveness.

The current invention proposes a system which helps engineering managers gain better visibility into their development team. This tool focuses on increasing team productivity and helps managers be data-driven. The tool includes concrete metrics for daily stand-ups, 1-to-1 meetings, checking the history of the engineers work and benchmarking stats with the industry.

None of the previous inventions and patents, taken either singly or in combination, is seen to describe the instant invention as claimed. Hence, the inventors of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a tool to assist engineering managers gain better visibility and enhance team productivity.

It is also the objective of the invention to provide an exclusive system which assist managers to be data driven and take decisions based on statistical figures and analysis.

It is another object of the invention is to provide a tool to generate reports for managers without any human input.

It is further the objective of the invention to provide a system and procedure for recording and evaluating daily stand-ups including but not limited to work log, daily updates and time card.

It is moreover the objective of the invention to provide recording and evaluation of 1-to-1 meetings which includes formation of developer summary to check specific stats for each engineer, impact, throughput, productive throughput, efficiency, technical debt, days active, work type, commit risk and history for all commits.

It is further the objective of the invention to provide a detailed Dashboard to compare the metrics for total impact, code volume, commits volume, commits per active day with the industry standard.

It is moreover the objective of the invention to produce Project timeline and checking of complex stats for the project including but not limited to work volume per total impact, code volume, commits volume, commits per active day, work trends: absolute, relative, stacked and top performers for each metric: new work, churn, legacy refactor and help others.

Another object of the present invention to provide a management system that can handle reliably and efficiently information about individual and bring useful evaluation for managers as per their requirements and multiple performance indicators.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURES, and Claims.

### DETAILED DESCRIPTION OF DRAWINGS

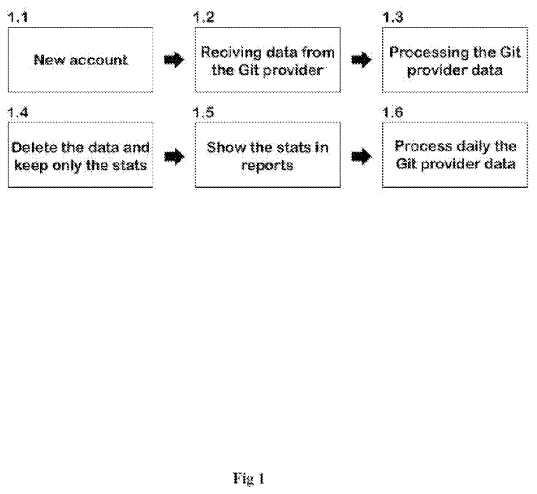

FIG. 1—FIG. 1 depicts the process flow of the system.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses an efficient system of storing, managing, evaluating and producing statistical output on engineering team performance evaluation.

The current tool as per its preferred embodiments provides concrete metrics for daily stand-ups, 1-to-1 meetings, checking the history of the engineers' work and benchmarking the employee statistics with the industry.

The system as per its additional embodiments allows for Daily standups features including creation of worklog to monitor the output for each commit or merge, daily. The daily update section allows to check daily impact, compared with last week's impact. Furthermore, the time card allows to check most frequent hours with commits, for the whole project and each engineer.

The system further allows to create one-to-one meetings with the engineers and also aims to provide further utility including developer summary to check specific stats for each engineer and the impact, throughput, productive throughput, efficiency, technical debt, days active, work type, commit risk and history for all commits.

The current invention also allows to check the health of the engineering teams over a long period of time and provide enhanced features like developing project timeline and to check complex statistics for the project including work volume per total impact, code volume, commits volume, commits per active day, work trends: absolute, relative, stacked and top performers for each metric: new work, churn, legacy refactor and help others.

The Dashboard also further allows to compare the metrics for total impact, code volume, commits volume, commits per active day with the industry standard.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I: A performance evaluation system, comprising:
a) a performance evaluation module configured to enable engineering employees performance reviews based on completion of a plurality of tasks and a plurality of skills required to complete the tasks for each of a plurality of projects on which an employee is staffed, wherein the performance evaluation module returns an employee performance score for the employee in relation to other employees at comparable job levels as the employee;
b) a module configured to enable a user apply proficiency rating in a desired skill and a length of time for which the candidate employee has utilized the desired skill;
c) a module configured to enable an exclusive system which assist managers to be data driven and take decisions based on statistical figures and analysis.
d) a module configured to enable to provide a tool to generate reports for managers without any human input.
e) a module configured to enable for recording and evaluating daily stand-ups including but not limited to work log, daily updates and time card.
f) a module configured to enable to provide recording and evaluation of 1-to-1 meetings which includes formation of developer summary to check specific stats for each engineer, impact, throughput, productive throughput, efficiency, technical debt, days active, work type, commit risk and history for all commits.
g) a module configured to provide a detailed Dashboard to compare the metrics for total impact, code volume, commits volume, commits per active day with the industry standard.
h) a module configured to enable to produce project timeline and checking of complex stats for the project including but not limited to work volume per total impact, code volume, commits volume, commits per active day, work trends: absolute, relative, stacked and top performers for each metric: new work, churn, legacy refactor and help others.
i) a module configured to provide a management system that can handle reliably and efficiently information about individual and bring useful evaluation for managers as per their requirements and multiple performance indicators.
